(19) United States
(12) Patent Application Publication
(10) Pub. No.: US 2024/0379315 A1
(43) Pub. Date: Nov. 14, 2024

(54) BREAKER DEVICE

(71) Applicant: Panasonic Intellectual Property Management Co., Ltd., Osaka (JP)

(72) Inventors: MASATO NAKAMURA, Hyogo (JP); SHUN ITO, Hyogo (JP)

(21) Appl. No.: 18/692,127

(22) PCT Filed: Oct. 19, 2022
(86) PCT No.: PCT/JP2022/038877

§ 371 Date: Mar. 14, 2024

(30) Foreign Application Priority Data
Oct. 27, 2021 (JP) 2021-175869

(51) Int. Cl. H01H 85/43; H01H 85/10

(52) U.S. Cl. CPC H01H 85/43; H01H 85/10

(57) ABSTRACT

This breaker device includes: a holder including a first internal space and a second internal space located below the first internal space; a conductor located between the first internal space and the second internal space and held on the holder; a pusher disposed in the first internal space; and a drive source that moves the pusher from the first internal space toward the second internal space. The conductor includes: a first embedded portion held on the holder; a second embedded portion held on the holder; and a partition portion disposed between the first embedded portion and the second embedded portion. The pusher is located above the partition portion. The first embedded portion includes: a thin portion connected to the partition portion; and a thick portion located opposite the partition portion across the thin portion. The thickness of the thick portion in the up-down direction is greater than the thickness of the thin portion in the up-down direction.

### TECHNICAL FIELD

The present disclosure relates to breaker devices.

### BACKGROUND ART

Conventionally, research has been conducted on a breaker device that when an overcurrent such as a short-circuit current flows to an electrical circuit installed in an automobile or the like, cuts a conductor constituting a portion of the electrical circuit to prevent significant damage (for example, refer to Patent Literature (PTL) 1).

### CITATION LIST

### Patent Literature

PTL 1: Unexamined Japanese Patent Publication No. 2015-73398

### SUMMARY OF INVENTION

In recent years, the required current-carrying capacity of a breaker device has been increasing due to the advancement of electric vehicles, machine tools, and the like. A conductor of the breaker device needs to have a large cross-sectional area in order to ensure a sufficient current-carrying capacity. When split or cut, a conductor having a large cross-sectional area easily causes an electric arc. The electric arc is likely to spread from a cut section of the conductor as a starting point. Particularly, the electric arc that is spreading may cause a failure in electrical interruption by a breaker device or damage to the breaker device itself.

Thus, an object of the present disclosure is to provide a breaker device capable of reducing the spread of an electric arc when a conductor is cut.

A breaker device according to one aspect of the present disclosure includes: a holder including a first internal space and a second internal space located below the first internal space; a conductor located between the first internal space and the second internal space and held on the holder; a pusher disposed in the first internal space; and a drive source configured to move the pusher from the first internal space toward the second internal space. The conductor includes: a first embedded portion held on the holder; a second embedded portion held on the holder; and a partition portion disposed between the first embedded portion and the second embedded portion. The pusher is located above the partition portion. The first embedded portion includes: a thin portion connected to the partition portion; and a thick portion located opposite the partition portion across the thin portion. A thickness of the thick portion in an up-down direction is greater than a thickness of the thin portion in the up-down direction.

### BRIEF DESCRIPTION OF DRAWINGS

FIG. 1 is a perspective view illustrating the configuration of a breaker device according to an exemplary embodiment.

FIG. 2 is a cross-sectional view illustrating the configuration of a breaker device according to an exemplary embodiment.

FIG. 3 is a plan view illustrating one pair of embedded portions and a partition portion according to an exemplary embodiment.

FIG. 4 is an enlarged cross-sectional view illustrating the area surrounded by the dashed line in FIG. 2.

FIG. 5 is a cross-sectional view of a breaker device according to an exemplary embodiment, illustrating a conductor that has been cut.

FIG. 6 is a cross-sectional view of a breaker device according to Variation 1, illustrating a conductor that has been cut.

FIG. 7 is a cross-sectional view illustrating the shape of a bottom according to Variation 2.

FIG. 8 is a cross-sectional view illustrating a conductor according to Variation 3.

### DESCRIPTION OF EMBODIMENTS

A breaker device according to one aspect of the present disclosure includes: a conductor; a holder configured to hold the conductor and including a first space and a second space separated from each other by the conductor; a pusher disposed in the first space; and a drive source configured to move the pusher from the first space to the second space. The conductor includes: a partition portion separating the first space and the second space from each other; and a pair of embedded portions sandwiching the partition portion and continuous to the partition portion. At least one of the pair of embedded portions includes: a thin portion continuous to the partition portion; and a thick portion continuous to the thin portion on an opposite side from the partition portion, the thick portion being thicker than the thin portion.

Thus, in the conductor, the thin portion and the thick portion thicker than the thin portion are provided in at least one of the pair of embedded portions. The cutting of the conductor results in the partition portion continuous to the thin portion being cut. This means that the cutting occurs at a portion having a cross-sectional area smaller than that of the thick portion, and therefore the electric arc generation area can be reduced. Thus, the spread of an electric arc can be reduced.

Furthermore, a principal surface of the thin portion that is located on the second space side may be positioned closer to the first space than a principal surface of the thick portion that is located on the second space side is.

Thus, the principal surface of the thin portion of the conductor that is located on the second space side is positioned closer to the first space than the principal surface of the thick portion of the conductor that is located on the second space side is. This means that in the conductor, a recess is formed on the thin portion on the second space side. A portion of the holder fits into this recess. Therefore, when the pusher moves from the first space to the second space to push the partition portion toward the second space, said portion of the holder can act as a wedge, and the conductor can be smoothly cut.

Furthermore, the length of the thin portion in a width direction intersecting a direction of extension in which the thin portion extends from the thick portion may be less than the length of the thick portion in said width direction.

Thus, the length of the thin portion in the width direction is less than the length of the thick portion in the width direction, meaning that the cross-sectional area of a portion to be cut by the pusher can be smaller. In other words, the electric arc generation area can be further reduced, and thus the spread of an electric arc can be further reduced.

Furthermore, a border portion between the thin portion and the thick portion may include an inclined surface.

When an electric arc is generated or when the drive source operates to move the pusher from the first space to the second space, for example, gas is generated. The gas flows into the spacing between the thin portion and the holder. If the border between the thin portion and the thick portion is formed in the form of a step, there is a risk that the gas may accumulate at a corner thereof and damage the holder. According to the present aspect, the inclined surface is formed on the border portion between the thin portion and the thick portion, and thus the gas flows smoothly along the inclined surface and can be prevented from accumulating inside the holder. Therefore, it is possible to reduce damage to the holder that is caused by the gas.

Furthermore, in the state resulting from the pusher cutting off the partition portion of the conductor and moving from the first space to the second space by the drive source, the pusher includes: a first opposing portion that opposes one of the pair of embedded portions; and a second opposing portion that opposes the other of the pair of embedded portions, and a first length that is the shortest length of a line extending on an outer surface of the pusher and connecting the first opposing portion and the second opposing portion as viewed in a direction of movement of the pusher is preferably greater than a second length that is the shortest length of a line extending on the outer surface of the pusher and connecting the first opposing portion, a bottom of the pusher, and the second opposing portion as viewed in a direction orthogonal to the direction of movement of the pusher.

Thus, when the pusher has moved to the second space, the first length is greater than the second length and therefore, the electric arc selects to pass through the path connecting the first opposing portion, the bottom of the pusher, and the second opposing portion which are included in the line of the second length. When a member for minimizing an electric arc is disposed near the bottom of the pusher, said member can minimize the electric arc. Thus, the spread of an electric arc can be further reduced.

Furthermore, in the state resulting from the pusher cutting off the partition portion of the conductor and moving from the first space to the second space by the drive source, the pusher includes: a first opposing portion that opposes one of the pair of embedded portions; and a second opposing portion that opposes the other of the pair of embedded portions, and a first length that is the shortest length of a line extending on an outer surface of the pusher and connecting the first opposing portion and the second opposing portion as viewed in a direction of movement of the pusher may be greater than a third length that is the shortest length of a line extending on outer surfaces of the pusher and the partition portion and connecting the first opposing portion, a bottom of the partition portion that overlaps a bottom of the pusher, and the second opposing portion as viewed in a direction orthogonal to the direction of movement of the pusher.

Thus, when the pusher has moved to the second space, the third length is greater than the second length and therefore, the electric arc selects to pass through the path connecting the first opposing portion, the bottom of the partition portion that overlaps the bottom of the pusher, and the second opposing portion which are included in the line of the third length. When a member for minimizing an electric arc is disposed near the partition portion that has been cut off, said member can minimize the electric arc. Thus, the spread of an electric arc can be further reduced.

Furthermore, the partition portion may include a groove located outside of an outer surface of the pusher as viewed in a direction of movement of the pusher.

Thus, the partition portion includes a groove located outside of the outer surface of the pusher as viewed in the direction of movement of the pusher, and therefore when the pusher pushes the partition portion into the second space, the partition portion is cut off from the groove as a starting point. Therefore, the conductor can be smoothly cut.

Furthermore, the thin portion may include a groove extending along an outer surface of the pusher.

Thus, the groove extending along the outer surface of the pusher is formed in the thin portion, meaning that the groove is embedded in the holder. Therefore, the groove allows for a reduction in the cross-sectional area of a cut portion of the conductor and also allows for a further reduction in the spread of an electric arc.

Furthermore, a bottom of the pusher may include a projection projecting laterally at a portion corresponding to the groove.

Thus, the projection projecting laterally is formed at a portion of the bottom of the pusher that corresponds to the groove, meaning that the projection can be positioned near the groove. With the projection and the groove, the conductor can be more smoothly cut.

Furthermore, a length of the projection in a direction of movement of the pusher may be less than the thickness of the thin portion.

If the projection is provided throughout the entire length of the pusher, the spacing between the holder and the pusher (projection) will be narrower than that formed when the projection is not formed on the pusher. When an electric arc is generated, a large pressure is generated in the breaker device (holder). Therefore, if the projection is provided throughout the entire length of the pusher, there is a risk that the generated pressure may damage the holder, the pusher, or the like. Thus, according to the present aspect, the projection is formed so that the length thereof in the direction of movement of the pusher becomes less than the thickness of the thin portion. With this, it is possible to split or cut the conductor while keeping the holder, the pusher, or the like from being torn or cut and also keeping the pusher from being misaligned.

### EXEMPLARY EMBODIMENT

Hereinafter, a breaker device according to an exemplary embodiment (including variations thereof) of the present disclosure will be described below. Note that each exemplary embodiment described below shows a general or specific example. The numerical values, shapes, materials, structural elements, the arrangement and connection of the structural elements, manufacturing steps, the order of the manufacturing steps, etc., shown in the following exemplary embodiment are mere examples, and are not intended to limit the present disclosure. In the figures, dimensions, etc., are not precise. In each of the figures, a structural element that is substantially the same as that in another figure is assigned the same reference sign.

In the following description and the drawings, the longitudinal direction of the conductor is defined as an X-axis direction, the width direction of the conductor is defined as a Y-axis direction, and the thickness direction of the conductor is defined as a Z-axis direction. These X-axis, Y-axis, and Z-axis directions intersect with each other (in the present exemplary embodiment, these are orthogonal to each other). Note that depending on the mode of use, it is conceivable that the Z-axis direction may be a direction other than the up-down direction; however, for the sake of description, the following description assumes that the Z-axis direction is the up-down direction.

In the present disclosure, there are cases where terms indicating directions such as “up/upper/above/top”, “down/lower/below/bottom”, “left”, “right”, “front/forward”, and “back/backward/rear/rearward” are used in the description; these directions merely indicate relative positioning and do not limit the present disclosure. For example, there are cases where the orientation of breaker device 1 in actual use and the orientation of breaker device 1 described in the present disclosure do not match.

In the following description, the positive X-axis direction represents the direction of the X-axis arrow, and the negative X-axis direction represents the direction opposite to the positive X-axis direction. The simple term “X-axis direction” indicates one or both of the positive X-axis direction and the negative X-axis direction. The same applies to the Y-axis direction and the Z-axis direction as well. An expression indicating a relative direction or a posture such as “parallel” and “orthogonal” encompasses a direction or posture that is not the intended direction or posture in a strict sense. For example, the sentence “two directions are parallel” not only means that said two directions are perfectly parallel, but also means that said two directions are substantially parallel, specifically, for example, about a few percent difference between said two directions is allowed.

### Configuration of Breaker Device

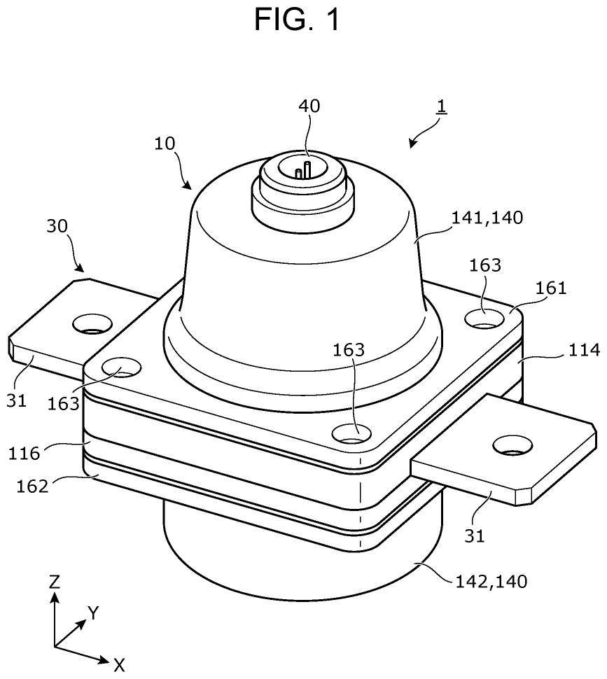

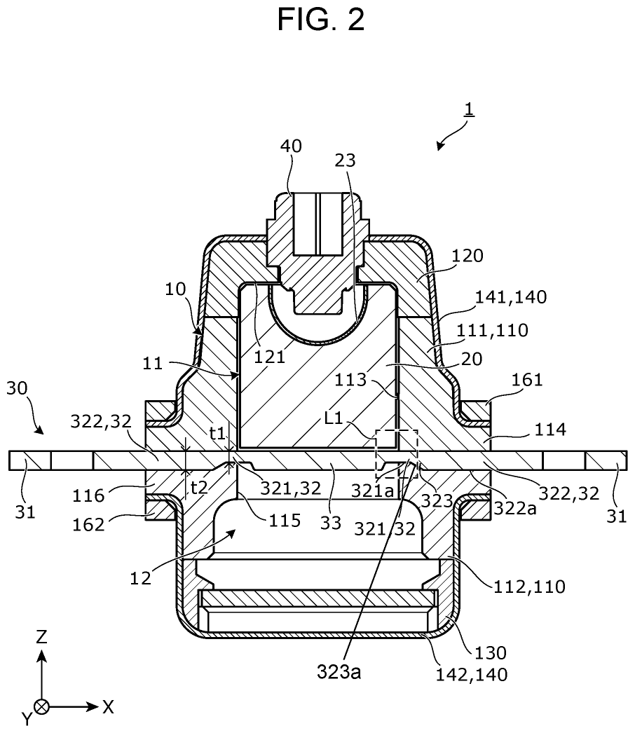

Hereinafter, the breaker device according to the exemplary embodiment will be described. First, the configuration of the breaker device according to the exemplary embodiment will be described with reference to FIG. 1 and FIG. 2. FIG. 1 is a perspective view illustrating the configuration of breaker device 1 according to the exemplary embodiment. FIG. 2 is a cross-sectional view illustrating the configuration of breaker device 1 according to the exemplary embodiment.

Breaker device 1 includes holder 10, conductor 30, pusher 20, and drive source 40. Breaker device 1 is, for example, an electrical circuit breaker device that is installed in a vehicle such as an automobile or an electric appliance such as a home appliance and when an overcurrent occurs, interrupts an electrical circuit. Examples of the vehicle include a vehicle including a battery pack such as a battery electric vehicle (BEV) or a plug-in hybrid electric vehicle (PHEV). Note that breaker device 1 may be installed in an object including an electrical circuit other than the vehicle or the electric appliance. The overcurrent is a large current that does not normally flow to conductor 30; for example, the overcurrent is an abnormal current that flows when an anomaly occurs in another device.

Holder 10 is a part that holds pusher 20, conductor 30, and drive source 40. Holder 10 houses pusher 20, conductor 30, and drive source 40 with a portion of conductor 30 and a portion of drive source 40 exposed. The interior of holder 10 before an electric current is interrupted includes: first space 11 located above conductor 30; and second space 12 located below conductor 30. A cooler for cooling an electric arc (not illustrated in the drawings) is disposed in second space 12. As the cooler, sand, alumina, hydrogen gas, oil, steel wool, glass wool, and the like can be used, for example.

Specifically, holder 10 includes: first holder 110 that holds pusher 20 and conductor 30; second holder 120 that holds drive source 40; third holder 130 for receiving pusher 20 that has moved; and cover portion 140 that covers first holder 110, second holder 120, and third holder 130.

First holder 110 includes upper holder 111 and lower holder 112 which are aligned in the Z-axis direction (up-down direction). Upper holder 111, which is disposed above conductor 30, is a cylindrical insulating member having first opening 113 extending through upper holder 111 in the Z-axis direction (up-down direction). First flange portion 114 protruding outward along the entire perimeter is formed at a lower end portion of upper holder 111.

Lower holder 112, which is disposed below conductor 30, is a cylindrical insulating member having second opening 115 extending through lower holder 112 in the Z-axis direction (up-down direction). Conductor 30 is sandwiched between and thus held by lower holder 112 and upper holder 111. Second opening 115 is disposed co-axially with first opening 113. Second opening 115 is formed to be narrower in width (inside dimension) at an upper portion than at a lower portion. An inner peripheral surface forming the upper portion of second opening 115 and an inner peripheral surface forming first opening 113 have generally overlapping shapes as viewed in the Z-axis direction. Second flange portion 116 protruding outward along the entire perimeter is formed at an upper end portion of lower holder 112.

Second holder 120 is a cylindrical insulating member stacked on upper holder 111 from above. As viewed in the Z-axis direction, drive source 40 penetrates second holder 120 in the Z-axis direction and fits with a central portion of second holder 120. Furthermore, recess 121 which accommodates the top of pusher 20 is formed in the lower surface of second holder 120.

Third holder 130 is a cylindrical insulating member stacked on lower holder 112 from below. In the Z-axis direction, a central portion of third holder 130 is closed, and this portion receives pusher 20 that has moved.

Cover portion 140 includes first cover 141 and second cover 142. First cover 141 covers upper holder 111 and second holder 120 from above. Drive source 40 projects from first cover 141. First protector 161, which is in the shape of a board, is attached to the upper surface of the peripheral edge of first cover 141. Thus, first cover 141 and first protector 161 cover the upper surface of first flange portion 114 of upper holder 111.

Second cover 142 covers lower holder 112 and third holder 130 from below. Second protector 162, which is in the shape of a board, is attached to the lower surface of the peripheral edge of second cover 142. Thus, second cover 142 and second protector 162 cover the lower surface of second flange portion 116 of lower holder 112.

As illustrated in FIG. 1, fixing holes 163 are formed at corner portions of first protector 161, first cover 141, upper holder 111, lower holder 112, second cover 142, and second protector 162. Fastening components not illustrated in the drawings are attached to fixing holes 163; with these, first protector 161, first cover 141, upper holder 111, lower holder 112, second cover 142, and second protector 162 are integrally fixed.

As illustrated in FIG. 2, pusher 20 is a columnar insulating member. Conductor 30 supports pusher 20 from below. Housing recess 23 which accommodates the bottom of drive source 40 is formed in the upper surface of pusher 20.

Drive source 40 is a gas generator that generates gas in first space 11 to drive pusher 20 toward second space 12. Drive source 40 includes: a pair of electrode pins; a heat-generating element connected to the pair of electrode pins; and a fuel (gunpowder) placed near the heat-generating element. The fuel is exposed from a lower end portion of drive source 40 in housing recess 23 of pusher 20. When the pair of electrode pins are energized on the basis of the control by an external control device, the heat-generating element generates heat and increases the temperature of the fuel. As a result, the fuel burns and gas is generated in housing recess 23. With the gas generated, pusher 20 moves from first space 11 toward second space 12. In other words, pusher 20 moves from an area located above conductor 30 (in the positive Z-axis direction) to an area located below conductor 30 (in the negative Z-axis direction).

Conductor 30, which is a conductive member in the shape of a board elongated in the X-axis direction, is formed so that the upper surface thereof is flat as a whole. Conductor 30 includes a pair of end portions 31, a pair of embedded portions 32, and partition portion 33.

The pair of end portions 31 are portions projecting outward from first holder 110. Specifically, one of the pair of end portions 31 is an end located in the negative X-axis direction, and the other of the pair of end portions 31 is an end located in the positive X-axis direction. The pair of embedded portions 32, which are portions located inward of the pair of end portions 31 in the X-axis direction, are continuous to the pair of end portions 31, respectively. The pair of embedded portions 32 are embedded in first holder 110.

Partition portion 33, which is a portion located between the pair of embedded portions 32, is continuous to the pair of embedded portions 32. Partition portion 33 is provided in the form of a bridge in the internal space of first holder 110 so as to separate first space 11 and second space 12 from each other.

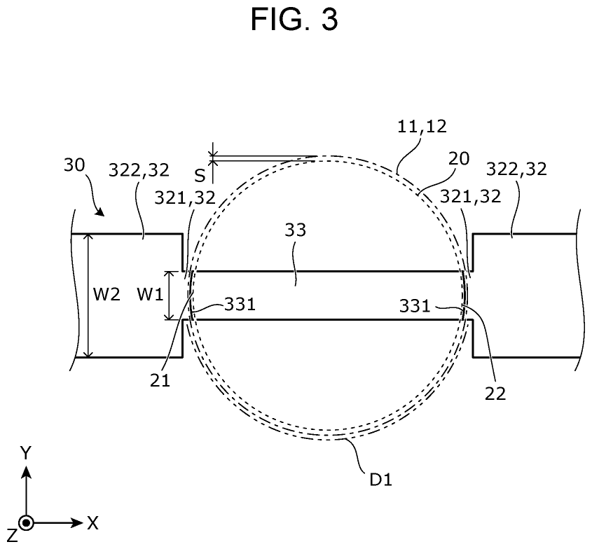

FIG. 3 is a plan view illustrating one pair of embedded portions 32 and partition portion 33 according to the exemplary embodiment. In FIG. 3, in first holder 110, the internal form of the cylindrical portion of each of first space 11 and second space 12 is indicated by the dashed-dotted line, and the external form of pusher 20 is indicated by the dashed line. Spacing S between the external form of the internal space of first holder 110 and the external form of pusher 20 is between 0.2 mm and 1.2 mm, inclusive.

As illustrated in FIG. 2 and FIG. 3, each embedded portion 32 includes: thin portion 321 continuous to partition portion 33; and thick portion 322 that is located on the opposite side of thin portion 321 from partition portion 33 and continuous to thin portion 321 via border portion 323.

As illustrated in FIG. 2, thickness t1 of thin portion 321 (the length thereof in the Z-axis direction) is less than thickness t2 of thick portion 322. Principal surface 321a (the lower surface) of thin portion 321 that is located on the second space 12 side is positioned closer to first space 11 than principal surface 322a (the lower surface) of thick portion 322 that is located on the second space 12 side is. Lower surface 323a of border portion 323 that is located on the second space 12 side is an inclined surface. Lower surface 323a of border portion 323 is inclined further downward with increasing distance from thin portion 321.

As illustrated in FIG. 3, length W1 of thin portion 321 in the width direction (Y-axis direction) intersecting a direction of extension (X-axis direction) in which thin portion 321 extends from thick portion 322 is less than length W2 of thick portion 322 in the width direction. Partition portion 33 is provided to extend in the X-axis direction in such a manner that the length thereof in the width direction remains the same as length W1 of thin portion 321 in the width direction. The cross-sectional shape of partition portion 33 at the boundary between thin portion 321 and partition portion 33 is substantially the same as that of thin portion 321.

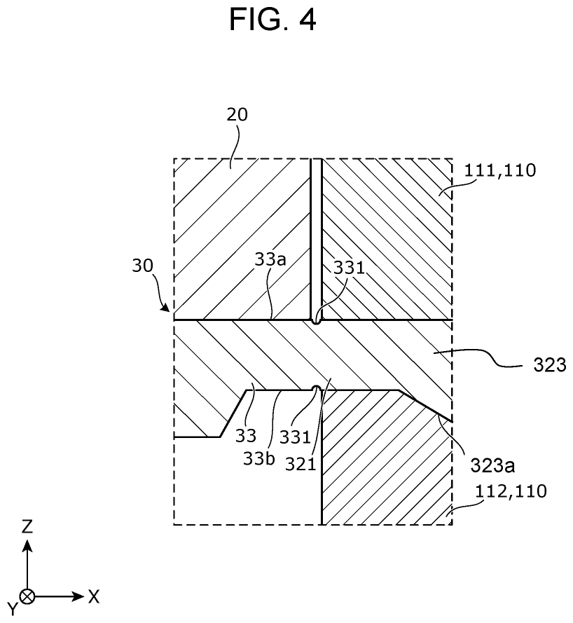

FIG. 4 is an enlarged cross-sectional view illustrating the area surrounded by dashed line L1 in FIG. 2. As illustrated in FIG. 4, first groove 331 (a groove) is formed in each of principal surface 33a (the upper surface) of partition portion 33 that is on the first space 11 side and principal surface 33b (the lower surface) of partition portion 33 that is on the second space 12 side. As illustrated in FIG. 3, first grooves 331 are provided at ends of partition portion 33 that are opposite in the X-axis direction. First groove 331 is positioned outside of the outer surface of pusher 20 as viewed in the Z-axis direction (as viewed in the direction of movement of pusher 20). First groove 331 is formed in a curve projecting outward in the X-axis direction so as to fit with the outer surface of pusher 20. At the time when pusher 20 moves from first space 11 toward second space 12, since first grooves 331 are formed in partition portion 33, conductor 30 is cut from first grooves 331 as a starting point, and partition portion 33 is cut off from conductor 30.

### Operation of Breaker Device

Next, the operation of breaker device 1 will be described. Before an overcurrent occurs, that is, during normal operation, breaker device 1 is as illustrated in FIG. 2. When an overcurrent occurs in an electrical circuit of an electric appliance or a vehicle in which breaker device 1 is installed, the pair of electrode pins of drive source 40 are energized on the basis of the control by the control device external to breaker device 1. Accordingly, the heat-generating element of drive source 40 generates heat and increases the temperature of the fuel. When the fuel burns and gas is generated in housing recess 23, pusher 20 moves from first space 11 toward second space 12. As a result of this movement, partition portion 33 is separated from conductor 30. Partition portion 33 that has been cut off moves downward along with pusher 20.

An electric arc is generated at the time when partition portion 33 is cut off from conductor 30. The cross-sectional shape of a portion of conductor 30 that is cut by pusher 20 is substantially the same as the cross-sectional shape of thin portion 321. As mentioned above, thin portion 321 connected to partition portion 33 is thinner than thick portion 322 and is also shorter in the width direction than thick portion 322. Thus, the cut portion has a cross-sectional area smaller than that thick portion 322 would have. This cut portion is also where an electric arc is generated. A reduction in the cross-sectional area of this cut portion allows for a reduction in the area of the region where an electric arc is generated, making it possible to reduce the spread of the electric arc.

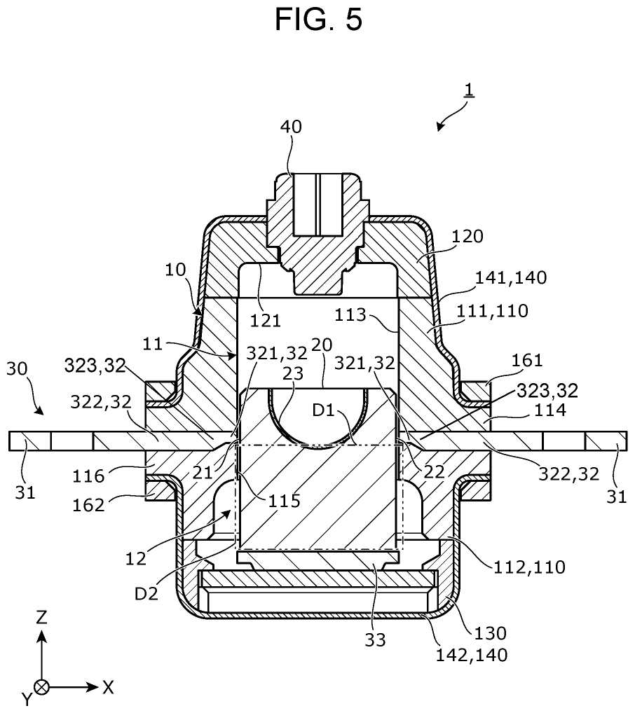

FIG. 5 is a cross-sectional view of breaker device 1 according to the exemplary embodiment, illustrating conductor 30 that has been cut. FIG. 5 is a diagram corresponding to FIG. 2. More specifically, FIG. 5 illustrates the state resulting from partition portion 33 being separated from conductor 30 by drive source 40 causing pusher 20 to cut conductor 30 and then partition portion 33 separated having moved from first space 11 toward second space 12. In this state, pusher 20 includes: first opposing portion 21 that opposes one of embedded portions 32 that is located in the negative X-axis direction; and second opposing portion 22 that opposes the other of embedded portions 32 that is located in the positive X-axis direction. First opposing portion 21 and second opposing portion 22 are portions of the outer surface of pusher 20 that face away from each other in the X-axis direction. Assume that, as viewed in the Z-axis direction (as viewed in the direction of movement of pusher 20), the length of the shortest line connecting first opposing portion 21 and second opposing portion 22 on the outer surface of pusher 20 is defined as first length D1, as illustrated in FIG. 3. First length D1 is the length of a straight line along the XY plane as viewed in the Y-axis direction (as viewed in the direction intersecting the direction of movement of pusher 20), as illustrated in FIG. 5. Assume that, as viewed in the Y-axis direction, the length of the shortest line connecting first opposing portion 21, the bottom of pusher 20, and second opposing portion 22 on the outer surface of pusher 20 is defined as second length D2. It is preferable that first length D1 be set greater than second length D2. Since an electric arc has the property of passing through a short path, the electric arc generated as a result of conductor 30 being cut will pass through the path indicated by second length D2. The electric arc passing through the path indicated by second length D2 is cooled by passing by the cooler, and the spread of the electric arc is further reduced.

### Advantageous Effects, Etc.

As described above, breaker device 1 according to the above exemplary embodiment includes: conductor 30; holder 10 configured to hold conductor 30 and including first space 11 and second space 12 separated from each other by conductor 30; pusher 20 disposed in first space 11; and drive source 40 configured to move pusher 20 from first space 11 to second space 12. Conductor 30 includes: partition portion 33 configured to separate first space 11 and second space 12 from each other; and a pair of embedded portions 32 sandwiching partition portion 33 and continuous to partition portion 33. At least one of the pair of embedded portions 32 includes: thin portion 321 continuous to partition portion 33; and thick portion 322 that is continuous to thin portion 321 on the opposite side from partition portion 33 and is thicker than thin portion 321.

Thus, in conductor 30, thin portion 321 and thick portion 322 thicker than thin portion 321 are provided in at least one of the pair of embedded portions 32. The cutting of conductor 30 results in partition portion 33 continuous to thin portion 321 being cut. This means that the cutting occurs at a portion having a cross-sectional area smaller than that of thick portion 322, and therefore the electric arc generation area can be reduced. Thus, the spread of an electric arc can be reduced.

Furthermore, principal surface 321a of thin portion 321 that is located on the second space 12 side is positioned closer to first space 11 than principal surface 322a of thick portion 322 that is located on the second space 12 side is.

Thus, principal surface 321a of thin portion 321 of conductor 30 that is located on the second space 12 side is positioned closer to first space 11 than principal surface 322a of thick portion 322 of conductor 30 that is located on the second space 12 side is, meaning that in conductor 30, a recess is formed on thin portion 321 on the second space 12 side. A portion of lower holder 112 fits into this recess. Therefore, when pusher 20 moves from first space 11 toward second space 12 to push partition portion 33 toward second space 12, said portion of lower holder 112 can act as a wedge, and conductor 30 can be smoothly cut.

Length W1 of thin portion 321 in the width direction (Y-axis direction) intersecting a direction of extension (X-axis direction) in which thin portion 321 extends from thick portion 322 is less than length W2 of thick portion 322 in said width direction.

Thus, length W1 of thin portion 321 in the width direction is less than length W2 of thick portion 322 in the width direction, meaning that the cross-sectional area of a portion to be cut by pusher 20 can be smaller. In other words, the electric arc generation area can be further reduced, and thus the spread of an electric arc can be further reduced.

Lower surface 323a of border portion 323 between thin portion 321 and thick portion 322 is inclined further downward with increasing distance from thin portion 321.

When an electric arc is generated or when drive source 40 operates, for example, gas is generated. The gas flows into lower holder 112 from the spacing between thin portion 321 and lower holder 112. If the border between thin portion 321 and thick portion 322 is formed in the form of a step, there is a risk that the gas may accumulate at a corner thereof and damage lower holder 112. In the present exemplary embodiment, lower surface 323a of border portion 323 between thin portion 321 and thick portion 322 is an inclined surface, and thus the gas flows smoothly along lower surface 323a and can be prevented from accumulating inside lower holder 112. Therefore, it is possible to reduce damage to lower holder 112 that is caused by the gas.

Furthermore, in the state resulting from pusher 20 cutting off partition portion 33 from conductor 30 and moving from first space 11 toward second space 12 by drive source 40, pusher 20 includes: first opposing portion 21 that opposes one of the pair of embedded portions 32; and second opposing portion 22 that opposes the other of the pair of embedded portions 32. First length D1 that is the shortest length of a line extending on the outer surface of pusher 20 and connecting first opposing portion 21 and second opposing portion 22 as viewed in the direction of movement of pusher 20 (as viewed in the Z-axis direction) is greater than second length D2 that is the shortest length of a line extending on the outer surface of pusher 20 and connecting first opposing portion 21, the bottom of pusher 20, and second opposing portion 22 as viewed in a direction (Y-axis direction) orthogonal to the direction of movement of pusher 20.

Thus, when pusher 20 has moved toward second space 12, first length D1 is greater than second length D2 and therefore, an electric arc selects to pass through the path connecting first opposing portion 21, the bottom of pusher 20, and second opposing portion 22 which are included in the line of second length D2. When a member (cooler) for minimizing an electric arc is disposed near the bottom of pusher 20, said member can minimize the electric arc. Thus, the spread of an electric arc can be further reduced.

Furthermore, a cooler for cooling an electric arc generated due to the cutting off of partition portion 33 is disposed in second space 12.

Thus, a cooler for cooling an electric arc generated due to the cutting off of partition portion 33 is disposed in second space 12, meaning that the cooler can cool the electric arc, allowing the spread of the electric arc to be more reliably reduced.

Furthermore, partition portion 33 includes first groove 331 located outside of the outer surface of pusher 20 as viewed in the direction of movement of pusher 20 (as viewed in the Z-axis direction).

Thus, partition portion 33 includes first groove 331 located outside of the outer surface of pusher 20 as viewed in the direction of movement of pusher 20, and therefore when pusher 20 pushes partition portion 33 into second space 12, conductor 30 is cut from first groove 331 as a starting point. Therefore, conductor 30 can be smoothly cut.

Furthermore, spacing S between the external form of the internal space of first holder 110 and the external form of pusher 20 is between 0.2 mm and 1.2 mm, inclusive, making it possible to reduce the likelihood that an electric arc will circumferentially pass along the outer surface of pusher 20. Therefore, the circuit-breaking performance can improve.

### OTHER EXEMPLARY EMBODIMENTS

The breaker device according to the exemplary embodiment has been described thus far, but the present disclosure is not limited to the exemplary embodiment. Various modifications to the present exemplary embodiment and forms configured by combining structural elements in different exemplary embodiments that can be conceived by those skilled in the art may be included within the present disclosure as long as these do not depart from the essence of the present disclosure. Note that in the following description, parts that are the same as those in the above exemplary embodiment have the same reference signs as in the above exemplary embodiment, and description thereof may be omitted.

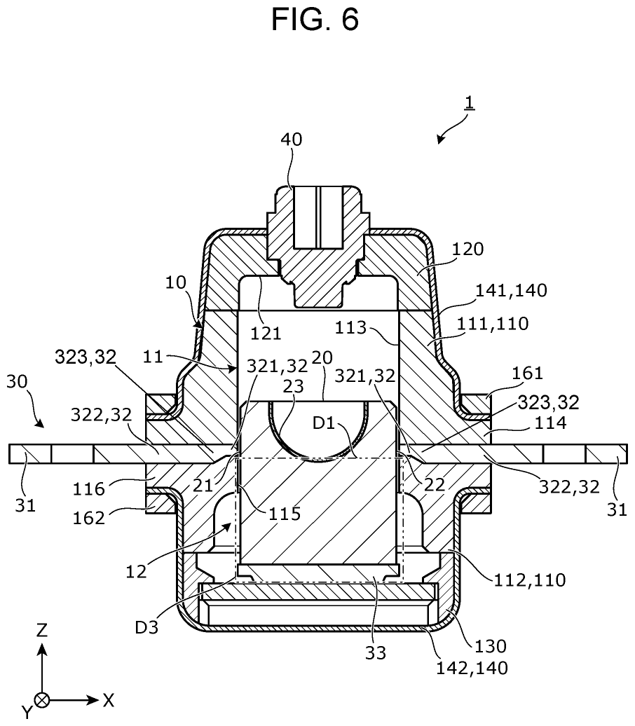

For example, the above exemplary embodiment describes an example in which first length D1 is greater than second length D2. However, first length D1 may be set greater than other reference lengths. FIG. 6 is a cross-sectional view of breaker device 1 according to Variation 1, illustrating conductor 30 that has been cut. FIG. 6 is a diagram corresponding to FIG. 5. In FIG. 6, third length D3 which is one example of other reference lengths is indicated. Third length D3 is the length of a line extending on the outer surface of partition portion 33 and pusher 20 and connecting first opposing portion 21, the bottom of partition portion 33 overlapping the bottom of pusher 20, and second opposing portion 22, as viewed in the Y-axis direction. In other words, it is sufficient that first length D1 be set greater than third length D3. In this case, the electric arc selects to pass through the path connecting first opposing portion 21, the bottom (the lower surface) of partition portion 33, and second opposing portion 22 which are included in the line of third length D3. Since the bottom of partition portion 33 is positioned immediately above the cooler, the electric arc can be closer to the cooler. Thus, the spread of an electric arc can be further reduced.

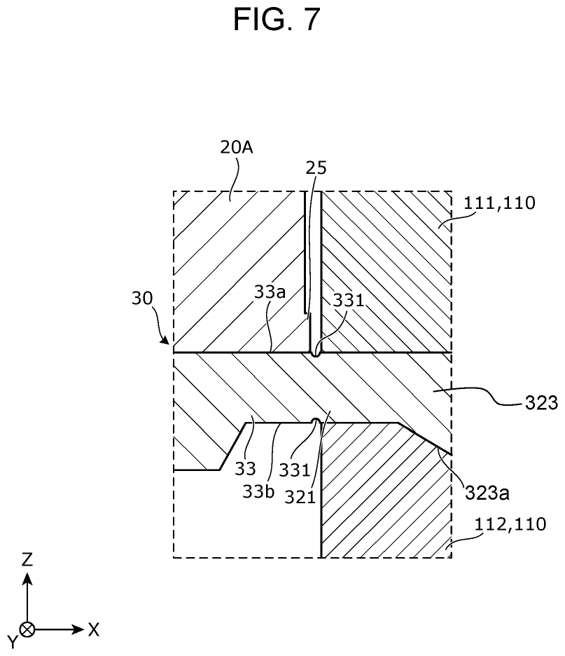

FIG. 7 is a cross-sectional view illustrating the shape of the bottom of pusher 20A according to Variation 2. Specifically, FIG. 7 is a diagram corresponding to FIG. 4. As illustrated in FIG. 7, projection 25 projecting laterally is formed at a portion of the bottom of pusher 20A that corresponds to first groove 331. Protrusion 25 may be continuously or discontinuously provided throughout the entire length of first groove 331 as viewed in the Z-axis direction. Alternatively, protrusion 25 may be provided only at a position facing one portion of first groove 331 as viewed in the Z-axis direction. The length of protrusion 25 in the Z-axis direction is less than the thickness of thin portion 321.

Thus, projection 25 projecting laterally is formed at a portion of the bottom of pusher 20A that corresponds to first groove 331, and therefore projection 25 can be positioned to extend close to first groove 331. Accordingly, with projection 25 and first groove 331, conductor 30 can be more smoothly cut.

When projection 25 is provided throughout the entire length of pusher 20A, the spacing between first holder 110 and pusher 20A (projection 25) is narrower than that when no projection is formed on the pusher. When an electric arc is generated, a large pressure is generated in breaker device 1 (holder 10). Therefore, if the projection is provided throughout the entire length of pusher 20A, there is a risk that the generated pressure may damage first holder 110, pusher 20A, and the like. Thus, in the present exemplary embodiment, projection 25 is formed so that the length thereof in the direction of movement of pusher 20A (Z-axis direction) becomes less than the thickness of thin portion 321. With this, it is possible to split or cut conductor 30 while keeping first holder 110, pusher 20A, and the like from being torn or cut and also keeping pusher 20A from being misaligned.

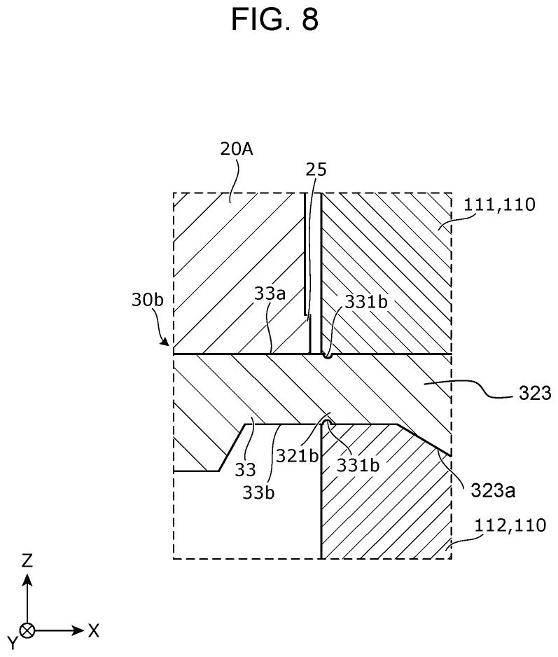

FIG. 8 is a cross-sectional view illustrating conductor 30b according to Variation 3. Specifically, FIG. 8 is a diagram corresponding to FIG. 7. As illustrated in FIG. 8, in Variation 3, first groove 331 is not formed in partition portion 33 of conductor 30b, and second groove 331b is formed in thin portion 321b of embedded portion 32. Specifically, second groove 331b (groove) extending along the outer surface of pusher 20A is formed in each principal surface of thin portion 321b. Thus, each second groove 331b is embedded in first holder 110. Therefore, second groove 331b allows for a reduction in the cross-sectional area of a cut portion of conductor 30b, and the spread of an electric arc can be further reduced.

The above exemplary embodiment describes an example in which length W1 of thin portion 321 in the width direction is less than length W2 of thick portion 322 in the width direction, but the length of the thin portion in the width direction and the length of the thick portion in the width direction may be substantially equal.

The above exemplary embodiment describes, as an example, conductor 30 having an upper surface that is flat as a whole and a lower surface that includes an irregular structure. However, the conductor may have a lower surface that is flat as a whole and an upper surface that includes an irregular structure. Specifically, in this case, the principal surface (the upper surface) of the thin portion that is located on the first space 11 side is positioned closer to the second space than the principal surface (the upper surface) of the thick portion that is located on the first space side is.

Furthermore, the above exemplary embodiment describes an example in which first groove 331 is formed in each of principal surface 33a (the upper surface) of partition portion 33 that is located on the first space 11 side and principal surface 33b (the lower surface) of partition portion 33 that is located on the second space 12 side, but the first groove may be formed only in at least one of the principal surfaces of the partition portion. Similarly, the second groove may be formed only in at least one of the principal surfaces of the thin portion. Alternatively, the groove does not need to be formed in partition portion 33.

The above exemplary embodiment describes an example in which each of the pair of embedded portions 32 includes thin portion 321 and thick portion 322, but only one of embedded portions 32 may include the thin portion and the thick portion.

Forms obtained by arbitrarily combining structural elements included in the above exemplary embodiment and variations thereof are included within the scope of the present disclosure.

### Summary

Breaker device 1 according to the first aspect of the present disclosure includes: holder 10 including first space 11 (a first internal space) and second space 12 located below first space 11 (a second internal space); conductor 30 located between first space 11 and second space 12 and held on holder 10; pusher 20 (20A) disposed in first space 11; and drive source 40 configured to move pusher 20 (20A) from first space 11 toward second space 12. Conductor 30 includes: a pair of embedded portions 32 held on holder 10; and partition portion 33 disposed between the pair of embedded portions 32. Pusher 20 (20A) is located above partition portion 33, at least one of the pair of embedded portions 32 includes: thin portion 321 connected to the partition portion; and thick portion 322 located opposite partition portion 33 across thin portion 321, and the thickness of thick portion 322 in the up-down direction is greater than the thickness of thin portion 321 in the up-down direction.

In breaker device 1 according to the second aspect of the present disclosure, the lower surface of thin portion 321 is located at a level higher than a level of the lower surface of thick portion 322.

In breaker device 1 according to the third aspect of the present disclosure, as illustrated in FIG. 3, the width (length W1) of thin portion 321 is less than the width (length W2) of thick portion 322 as viewed from above.

In breaker device 1 according to the fourth aspect of the present disclosure, as illustrated in FIG. 4, conductor 30 further includes border portion 323 connecting thick portion 322 (refer to FIG. 2) and thin portion 321, and lower surface 323a of border portion 323 is inclined further downward with increasing distance from thin portion 321.

Note that while border portion 323 is provided in the present disclosure, border portion 323 does not necessarily need to be provided.

In breaker device 1 according to the fifth aspect of the present disclosure, as illustrated in FIG. 5, in the state resulting from partition portion 33 being cut off from conductor 30 by the pusher moving from first space 11 to second space 12 by drive source 40, pusher 20 (20A) includes: first opposing portion 21 that opposes one of cut surfaces of conductor 30; and second opposing portion 22 that opposes the other of the cut surfaces of conductor 30, the length of a line extending on the outer surface of pusher 20 (20A) and connecting first opposing portion 21 and second opposing portion 22 is defined as first length D1, the length of a line extending on the outer surface of pusher 20 (20A) and connecting first opposing portion 21, the bottom of pusher 20, and second opposing portion 22 in the stated order is defined as second length D2, and first length D1 is greater than second length D2.

Note that while second length D2 is measured by measuring the length of the path passing through the center of the bottom of pusher 20 in the exemplary embodiment described with reference to FIG. 5, the length does not necessarily need to be measured by measuring the length of the path passing through the center of the bottom of pusher 20.

In breaker device 1 according to the sixth aspect of the present disclosure, as illustrated in FIG. 6, in the state resulting from partition portion 33 being cut off from conductor 30 by pusher 20 (20A) moving from first space 11 toward second space 12 by drive source 40, pusher 20 (20A) incudes: first opposing portion 21 that opposes one of cut surfaces of the conductor; and second opposing portion 22 that opposes the other of the cut surfaces of conductor 30, the length of a line extending on the outer surface of pusher 20 (20A) and connecting first opposing portion 21 and second opposing portion 22 as viewed from above is defined as first length D1, the length of a line extending on the outer surface of pusher 20 (20A) and connecting first opposing portion 21, the bottom of partition portion 33, and second opposing portion 22 in the stated order is defined as third length D3, and first length D1 is greater than third length D3.

Note that while third length D3 is measured by measuring the length of the path passing through the center of the bottom of partition portion 33 in the exemplary embodiment described with reference to FIG. 6, the length does not necessarily need to be measured by measuring the length of the path passing through the center of the bottom of partition portion 33.

In breaker device 1 according to the seventh aspect of the present disclosure, as illustrated in FIG. 4, partition portion 33 includes groove 331 located outside of pusher 20 (20A) as viewed from above.

In breaker device 1 according to the eighth aspect of the present disclosure, as illustrated in FIG. 8, thin portion 321b of embedded portion 32 includes grooves 331b extending along the outer surface of pusher 20A as viewed from above.

In breaker device 1 according to the ninth aspect of the present disclosure, as illustrated in FIG. 7 and FIG. 8, the bottom of pusher 20 (20A) includes, near grooves 331 (331b), projection 25 projecting outward.

In breaker device 1 according to the tenth aspect of the present disclosure, as illustrated in FIG. 7 and FIG. 8, the length of projection 25 in the up-down direction is less than the thickness of thin portion 321 (321b) in the up-down direction.

### INDUSTRIAL APPLICABILITY

The present disclosure is useful for a breaker device that interrupts an electrical path when an overcurrent occurs.

### REFERENCE SIGNS LIST

1 breaker device
10 holder
11 first space (internal space)
12 second space (internal space)
20, 20A pusher
21 first opposing portion
22 second opposing portion
23 housing recess
25 projection
30, 30b conductor
31 end portion
32 embedded portion
33 partition portion
33a, 33b, 321a, 322a principal surface
40 drive source
110 first holder
111 upper holder
112 lower holder
113 first opening
114 first flange portion
115 second opening
116 second flange portion
120 second holder
121 recess
130 third holder
140 cover portion
141 first cover
142 second cover
161 first protector
162 second protector
163 fixing hole
321, 321b thin portion
322 thick portion
323 border portion
323a lower surface
331 first groove (groove)
331b second groove (groove)
D1 first length
D2 second length
D3 third length
L1 dashed line
S spacing
W1, W2 length

1. A breaker device comprising:
a holder including a first internal space and a second internal space located below the first internal space;
a conductor located between the first internal space and the second internal space and held on the holder;
a pusher disposed in the first internal space; and
a drive source configured to move the pusher from the first internal space toward the second internal space, wherein
the conductor includes:
a first embedded portion held on the holder;
a second embedded portion held on the holder; and
a partition portion disposed between the first embedded portion and the second embedded portion,
the pusher is located above the partition portion,
the first embedded portion includes:
a thin portion connected to the partition portion; and
a thick portion located opposite the partition portion across the thin portion, and
a thickness of the thick portion in an up-down direction is greater than a thickness of the thin portion in the up-down direction.

2. The breaker device according to claim 1, wherein
a lower surface of the thin portion is located at a level higher than a level of a lower surface of the thick portion.

3. The breaker device according to claim 2, wherein
a width of the thin portion is less than a width of the thick portion as viewed from above.

4. The breaker device according to claim 1, wherein
the conductor further includes a border portion connecting the thick portion and the thin portion, and a lower surface of the border portion is inclined further downward with increasing distance from the thin portion.

5. The breaker device according to claim 1, wherein
in a state resulting from the partition portion being cut off from the conductor by the pusher moving from the first internal space toward the second internal space by the drive source,
the pusher includes:
a first opposing portion that opposes one of cut surfaces of the conductor; and
a second opposing portion that opposes the other of the cut surfaces of the conductor,
a length of a line extending on an outer surface of the pusher and connecting the first opposing portion and the second opposing portion as viewed from above is defined as a first length,
a length of a line extending on the outer surface of the pusher and connecting the first opposing portion, a bottom of the pusher, and the second opposing portion in the stated order is defined as a second length, and
the first length is greater than the second length.

6. The breaker device according to claim 1, wherein
in a state resulting from the partition portion being cut off from the conductor by the pusher moving from the first internal space toward the second internal space by the drive source,
the pusher includes:
a first opposing portion that opposes one of cut surfaces of the conductor; and
a second opposing portion that opposes the other of the cut surfaces of the conductor,
a length of a line extending on an outer surface of the pusher and connecting the first opposing portion and the second opposing portion as viewed from above is defined as a first length,
a length of line extending on the outer surface of the pusher and connecting the first opposing portion, a bottom of the partition portion, and the second opposing portion in the stated order is defined as a third length, and
the first length is greater than the third length.

7. The breaker device according to claim 1, wherein
the partition portion includes a groove located outside of the pusher as viewed from above.

8. The breaker device according to claim 1, wherein
the thin portion of the first embedded portion includes a groove extending along an outer surface of the pusher as viewed from above.

9. The breaker device according to claim 8, wherein
a bottom of the pusher includes, near the groove, a projection projecting outward.

10. The breaker device according to claim 9, wherein
a length of the projection in the up-down direction is less than the thickness of the thin portion in the up-down direction.
